(19) United States
(12) Patent Application Publication
(10) Pub. No.: US 2025/0204571 A1
(43) Pub. Date: Jun. 26, 2025

(54) METHOD OF MANUFACTURING A FUNCTIONAL OIL POWDER

(71) Applicant: METAL INDUSTRIES RESEARCH & DEVELOPMENT CENTRE, KAOHSIUNG (TW)

(72) Inventors: Jen-Wei SU, Kaohsiung City (TW); Wen-Lung MA, Kaohsiung City (TW); Pei-Jung LIEN, Kaohsiung City (TW)

(21) Appl. No.: 18/396,449

(22) Filed: Dec. 26, 2023

(51) Int. Cl. A23P 10/47; A23D 7/04

(52) U.S. Cl. CPC A23P 10/47; A23D 7/04

(57) ABSTRACT

The present invention is related to a method of manufacturing a functional oil powder. By using cyclodextrin and a microfluidic device, not only can the required temperature and time of an emulsification step decrease, but the obtained functional oil powder also can have excellent properties of encapsulation and stability. After a storage period, the functional oil powder hardly becomes wet. Moreover, there is no grease discharge and the microorganisms can hardly grow therein. Therefore, the present invention can be applied to make the product of the functional oil.

### BACKGROUND

### Field of Invention

The present invention relates to a method of manufacturing a functional oil powder. More particularly, the present invention relates to the method of manufacturing a functional oil powder including cyclodextrin and a microfluidic device.

### Description of Related Art

Edible oils are oils purified from animals or plants. The edible oils have a higher boiling point but a lower specific heat capacity than that of water. Therefore, compared to water, edible oils can transmit heat more easily and allow food to be cooked at a higher temperature, thereby shortening the heating time for cooking. Moreover, edible oils can improve food flavor, smell, and taste, and thus edible oils can be applied in the catering industries and food-processing industries. Some edible oils are rich in unsaturated fatty acids and have effects of anti-inflammatory, increasing the ratio of high-density lipoprotein cholesterol and preventing cardiovascular disease. In addition, some edible oils also contain other active substances such as fat-soluble vitamins (i.e., vitamins A, D, E, and K), carotene, and/or flavonoids, etc., and are excellent choices to make health supplements.

The edible oil products are normally liquid at room temperature. However, due to the flavor and taste of edible oils, the edible oils in liquid states are usually used as cooking oils and/or sauces and are hard to eat directly. Processing the edible oils into powders can not only improve the aforementioned problems but also extend the shelf life. A conserved method to form edible oil into a powder is to perform an emulsifying step and a spray drying step on the edible oils. However, a heat treatment (e.g., higher than 60° C.) is performed both in the emulsifying step and the spray drying step, resulting in not only the destruction of the partial active substances in the edible oil but also accelerated rancidity and oxidation of the edible oils.

In addition, to extend the shelf life, edible oil powders require food additives such as dispersing agents (i.e., magnesium stearate and/or silicon dioxide) to increase the properties of encapsulation and stability of the edible oil powders. However, since the approved food additives must comply with more strict rules in various countries, it is needed to add many kinds of food additives to achieve the same levels of the properties of encapsulation and stability, resulting in negative customer perception.

Therefore, a method of manufacturing a functional oil powder is required to solve the aforementioned problems.

### SUMMARY

Therefore, an aspect of the present invention is to provide a method of manufacturing a functional oil powder. The method uses cyclodextrin and a microfluidic device, so the obtained functional oil powder has excellent properties of encapsulation and stability.

According to the aforementioned aspect of the present invention, a method of manufacturing a functional oil powder is provided. First, an emulsifier is mixed in functional oil and stirred until the functional oil is emulsified to form an emulsified solution. Then, cyclodextrin is added to the emulsified solution and stirred until cyclodextrin forms a coating layer on the surface of the functional oil contained in the emulsified solution, thereby obtaining a modified emulsified solution.

Next, secondary emulsification is performed with a microfluidic device by passing the modified emulsified solution through the microfluidic device, thereby obtaining a homogeneous solution. The homogeneous solution contains 55 weight percent to 85 weight percent of the emulsifier, 1 weight percent to 15 weight percent of cyclodextrin, and 10 weight percent to 40 weight percent of the functional oil. Then, the homogeneous solution is lyophilized to obtain the functional oil powder.

According to some embodiments of a present invention, the functional oil includes Camellia seed oil, pumpkin seed oil, Sacha inchi oil, and/or fish oil.

According to some embodiments of a present invention, after adding cyclodextrin to the emulsified solution, the stirring is performed at 40° C. to 50° C.

According to some embodiments of a present invention, the pressure of the microfluidic device is set as 30 atmospheres (atm) to 50 atm.

According to some embodiments of a present invention, the flowing rate of the microfluidic device is 1 L/hour to 10 L/hour.

According to some embodiments of a present invention, the temperature of the microfluidic device is set as 10° C. to 40° C.

According to some embodiments of a present invention, the secondary emulsification is performed at 10° C. to 40° C.

According to some embodiments of a present invention, after a storage period, the functional oil powder has a water activity of less than 0.3.

According to some embodiments of a present invention, the functional oil powder has a water content of less than 3.4 weight percentage after a storage period.

According to some embodiments of a present invention, the aforementioned storage period is 1 week to 12 weeks.

By applying the method of manufacturing the functional oil powder of the present invention, cyclodextrin, and a microfluidic device are used to increase the properties of encapsulation and stability of the functional oil powder, thereby extending the shelf life of the functional oil powder. The method can be used to make functional oils into health supplements that can be eaten directly.

### BRIEF DESCRIPTION OF THE DRAWINGS

The invention can be more fully understood by reading the following detailed description of the embodiment, with reference made to the accompanying drawings as follows:

FIG. 1 illustrates the method of manufacturing a functional oil powder according to an embodiment according to the present invention.

### DETAILED DESCRIPTION

As mentioned above, the present invention provides a method of manufacturing a functional oil powder. By using cyclodextrin and the microfluidic device, the obtained functional oil powder can have excellent properties of encapsulation and stability, and therefore the shelf life of the functional oil can extend and the functional oil can be applied to produce the products of functional oils that can be eaten directly.

The phrase “functional oil” herein refers to edible oils that have health effects beyond their nutritional values. The main ingredients of functional oil are triglycerides which are glycerides formed by a dehydration condensation of glycerol and fatty acids. In some embodiments, the sources of functional oils are not limited and can originate from animals and/or plants. In some specific examples, the functional oils originating from animals can include but are not limited to fish oil, krill oil, and/or Pelodiscus sinensis oil. In some embodiments, the functional oils originating from plants can include but are not limited to walnut oil, coconut oil, avocado oil, Camellia seed oil, pumpkin seed oil, and/or Sacha inchi oil. In some embodiments, the health effects of functional oils can originate from the unsaturated fatty acids of the triglycerides. In some embodiments, the health effects of the functional oils can originate from the active substances soluble in the functional oils and can include but are not limited to fat-soluble vitamins (i.e., vitamins A, D, E, and K), astaxanthin, lycopene, and/or lutein.

The term “property of encapsulation” herein refers to the level of functional oils to be encapsulated in the functional oil powder. If the property of encapsulation is bad, there would be grease discharge in the functional oil powder, and therefore the functional oil powder becomes wet, agglomerated, and sticky. Moreover, the functional oils are easily exposed to air and turn rancid, and may even allow microorganisms to grow, indicating a bad stability of the functional oil powder.

In some embodiments, the better the property of encapsulation of the functional oil powder is, the lower the loss rate is. In some specific examples, the loss rate is the percentage rate of the difference between the amount of functional oil used for making the functional oil powder and the amount of functional oil in the functional oil powder to the amount of functional oil for making the functional oil powder. In some embodiments, the property of encapsulation can be evaluated by the covering rate which is the weight percentage of the functional oil contained in the functional oil powder that can be stable after a storage period. In some specific examples, the covering rate of the functional oil powder can be 10 weight percent to 40 weight percent, for example.

The term “stability” herein refers to the functional oil powder that can keep its steady state after a storage period at room temperature. That is, the functional oil powder is pulverous but not agglomerated, and no microorganism grows therein. It is neither oily nor greasy when touched, indicating that the functional oil powder does not become wet, there is no grease discharge, and the functional oil therein does not deteriorate. In some embodiments, the room temperature can be 10° C. to 40° C., e.g., 15° C. to 35° C., or 20° C. to 25° C., for example. In some embodiments, the aforementioned storage period can be bigger than 0 days to 180 days (about a half year), 7 days to 120 days (about 3 months), or 1 week to 12 weeks, for example.

In some embodiments, the stability of the functional oil powder can be evaluated by water content, acid value, water activity, and the number of microorganisms. The water content is the weight percentage of the weight of water to the total weight of functional oil powder. The water content of functional oil powder increases after a storage period at room temperature, indicating that the functional oil powder gets wet. On the other hand, a small range of change of the functional oil powder and/or a water content less than 4.0 weight percentage (i.e., less than 3.4 weight percentage) after a storage period at room temperature indicates that the functional oil powder has stability and does not get wet easily. In some specific examples, the water content can be the ratio of the difference between the weight of functional oil powder and the dry weight of functional oil powder subjecting to a halogen lamp and/or an infrared heating treatment to the weight of functional oil powder. In some specific examples, the water content can be evaluated by the Karl Fischer method, for example.

The acid value is the milligrams of potassium hydroxide required to neutralize the free fatty acid of every gram of functional oil in the functional oil powder. The acid value can be used to evaluate whether the functional oil in the functional oil powder deteriorated. In detail, after the functional oil contact with air, heat, acid, base, and/or microorganisms, the triglycerides therein are easily hydrolyzed and/or oxidized, thereby producing free fatty acid. Therefore, by measuring the acid value of the functional oil powder after the aforementioned storage period, the levels of the deterioration of the functional oil can be evaluated. Moreover, the acid value can be evaluated as the index to determine whether the properties of encapsulation of a functional oil powder change over time. A functional oil powder having excellent stabilities of the functional oil powder shows an acid value with a small range of change or an acid value less than 1.0 mg KOH/g after the aforementioned storage period at room temperature.

The water activity refers to the ratio value of the saturated vapor pressure of the functional oil powder to that of pure water under the same temperature in an enclosed space. The higher the water activity of a functional oil powder is, the more the amount of free water molecules is in the functional oil powder. These free water molecules can allow microorganisms to metabolize, grow, and reproduce. Therefore, the higher the water activity is, the harder the functional oil can be stored. On the other hand, the lower the water activity of a functional oil powder is, the harder the microorganism can survive, and the more excellent the stability of a functional oil powder is. In some embodiments, a functional oil powder with excellent stability has a water activity of less than 0.3, i.e., 0.27 after the aforementioned storage period at room temperature.

A plate culture agar is used for inoculation and microbial count to obtain the number of microorganisms in the functional oil powder. In some embodiments, the microorganisms can include but are not limited to bacteria and/or fungi. In some specific examples, the number of microorganisms can be determined by total bacterial count, Coliform count, Escherichia coli count, Salmonella count, Listeria monocytogenes count, Staphylococcus aureus count, and/or Vibrio parahaemolyticus count. In general, the total bacterial count of the functional oil powder per gram should be lower than 106 colony-forming units (CFU), e.g., lower than 3000 CFU/g, or lower than 1000 CFU/g.

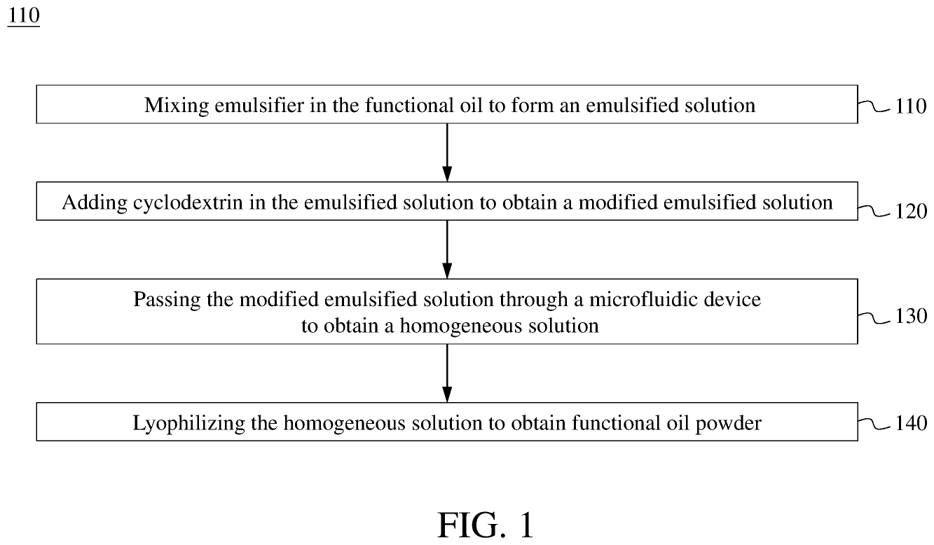

Referring to FIG. 1, which illustrates a method of manufacturing a functional oil powder 100 of the present invention. First, the emulsifier and functional oil are mixed and stirred until the functional oil is emulsified and forms an emulsified solution, as shown in step 110. In some embodiments, the emulsifier can be gum arabic, for example. The emulsifier can coat the oil drop formed by the functional oil, thereby preventing the functional oil from contacting external air and/or microorganisms as well as deteriorating.

In some embodiments, the water solution of gum arabic can be obtained by dissolving the gum arabic in hot water, for example. The gum arabic can be the exuded product originating from the trunk of a leguminous species of the family Fabaceae. The gum arabic has a complex composition that can include but is not limited to polysaccharides such as arabinose, galactose, glucuronic acid, and/or rhamnose, as well as salts such as calcium, magnesium, and/or potassium. Thus, gum arabic can be used as a stabilizer, an emulsifier, a thickener, or an excipient of food or medicine in food-processing industries and pharmaceutical industries. In some embodiments, the temperature of hot water can be 80° C. to 90° C., for example. In some embodiments, the weight of hot water is two to four times the weight of gum arabic powder.

Then, as step 120 shows, cyclodextrin is added to the emulsified solution and stirred until cyclodextrin forms a coating layer on the surface of the functional oil contained in the emulsified solution, thereby obtaining a modified emulsified solution. Cyclodextrin is a cyclic oligosaccharide formed by glucopyranoses and has low water solubility (about 15% to 25%). Using cyclodextrin can avoid the agglomeration of the gum arabic and functional oil. If cyclodextrin is not added, the obtained functional oil powder would have a bad property of encapsulation, and there would be grease discharge.

In some embodiments, cyclodextrin can include but is not limited to α-cyclodextrin, β-cyclodextrin, and/or γ-cyclodextrin. In some better embodiments, cyclodextrin is γ-cyclodextrin which has a better water solubility, so that the subsequent application of the functional oil powder can be easier.

In some embodiments, after cyclodextrin is added to the emulsified solution, the stirring can be performed at 40° C. to 50° C., for example, so that cyclodextrin and emulsified solution can be mixed thoroughly, thereby improving the properties of encapsulation and stability of the functional oil powder. Moreover, since the stirring is performed at a proper temperature, the active substance in the functional oil can be ensured not to be destroyed. In some embodiments, after cyclodextrin is added to the emulsified solution, the stirring time to form a coating layer on the surface of the functional oil can be 1 hour to 3 hours, for example.

It is worth noting that the functional oil powder using maltodextrin cannot reach the same level of stability as that of the functional oil powder using cyclodextrin with the same amount with experimental improvements. Moreover, in some embodiments, steps 110 and 120 need to be performed to reach better emulsification and modification effects, and thus the two steps cannot be performed in a different order or performed simultaneously.

Step 120 is followed by step 130, in which a secondary emulsification is performed with a microfluidic device by passing the modified emulsified solution through the microfluidic device, thereby obtaining a homogeneous solution. The homogeneous solution can include an emulsifier of 55 weight percent to 85 weight percent, a cyclodextrin of 1 weight percentage to 15 weight percent, and a functional oil of bigger than or equal to 10 weight percent to 40 weight percent. It is worth noting that if the amount of cyclodextrin is too low, the properties of encapsulation and stability of functional oil powder would not fulfill the requirement. If the amount of cyclodextrin is too high, the production cost would be enhanced, but the properties of encapsulation and stability of the functional oil powder would not be further improved. If the amount of functional oil is too high, the amount of emulsifier would be lower correspondingly, so the property of encapsulation of the obtained functional oil powder is not good. If the amount of the functional oil was too low, more functional oil powder would be needed to reach the effective dosage of the active substance contained in the functional oil, and thus the user experience would be not good.

In some specific examples, the amount of emulsifier of the homogeneous solution can be 60 weight percent, 65 weight percent, 70 weight percent, or 75 weight percent, for example. In some specific examples, the amount of cyclodextrin in the homogeneous solution can be 5 weight percent, 10 weight percent, or 15 weight percent, for example. In some specific examples, the amount of the functional oil of the homogeneous solution can be 10 weight percent, 15 weight percent, 20 weight percent, 25 weight percent, 30 weight percent, 35 weight percent, 40 weight percent, or 45 weight percent, for example.

There is no limitation on the microfluidic device and can be the commercially available microfluidic device, for example. In some embodiments, the microfluidic device has two liquid inlets in which the aforementioned modified emulsified solution inflows. In some embodiments, the place where the channels connecting the two inlets cross has a Y-shaped structure or an X-shaped structure. The pressure for driving the flow of the homogeneous solution in the microfluidic device is not limited and can be 30 atm to 50 atm, for example, so that the flow rate of the homogeneous solution is 1 L/hour to 10 L/hour, e.g., 3 L/hour to 8 L/hour. Noting that the step 130 can be performed at room temperature. The room temperature is defined above and will not be elaborated herein.

Next, as shown in step 140, the homogeneous solution is lyophilized to obtain functional oil powder. The temperature and time for the lyophilizing step are not limited and can be performed with a conventional method by the commercially available lyophilizing machine. By performing the lyophilizing step instead, the problem that the active substance will decompose under thermal treatment (e.g., above 60° C.) of the spray drying can be prevented.

Experiments have proven that the loss rate of the functional oil in the functional oil powder is 0.5% to 4.0%, indicating that the functional oil powder has excellent properties of encapsulation. In addition, the functional oil powder includes the functional oil of 10 weight percent to 40 weight percent. Moreover, after a storage period of 1 week to 12 weeks at room temperature, the functional oil powder is shown to have properties of encapsulation and stability when the water content is less than 5 weight percent, the acid value is less than 1.0 mg KOH/g, the water activity is less than 0.3, and the bacterial count is less than 1000 CFU/g.

By using cyclodextrin and the microfluidic device simultaneously, the time required for emulsifying the functional oil powder of the present invention can be shortened. It is worth noting that the emulsifying time is as long as 12 hours and even 24 hours in the conventional method of manufacturing since the microfluidic device is not used and the functional oil is emulsified by the emulsifier and the stirring only. Moreover, since the conventional method of manufacturing is batch processing, the yield is limited by the volume of a stirring tank. On the other hand, the use of the microfluidic device can decrease the time required for mixing the emulsifier and the functional oil. In addition, the microfluidic device can connect to other process equipment to perform the process continuously for being more advantageous in the designing of a production line.

Even if the silicon dioxide and/or magnesium stearate are excluded, the functional oil powder of the present invention would keep excellent or even better properties of encapsulation and stability by using cyclodextrin and the microfluidic device simultaneously. It is noted that the covering rate of the conventional oil powder cannot reach that of the present invention and is only 16 weight percent to 20 weight percent since the dispersing agent (e.g., silicon dioxide and/or magnesium stearate) used in the conventional oil powder has a high hydrophobicity, and thus the dispersing agent is usually added after the emulsification and spray drying process to prevent the dispersing agent from leaking out from the emulsified solution. Moreover, since the functional oil powder of the present invention has excellent properties of encapsulation and stability, the functional oil powder would be stored for a long time, and the microorganisms would hardly grow therein even if the antiseptics and/or the disinfectants are excluded. Therefore, the functional oil powder of the present invention can be used to extend the shelf life of the functional oil, and the method of manufacturing can be used to make the functional oil into health supplements that can be eaten directly.

Although the present invention has been described in considerable detail with reference to certain embodiments thereof, other embodiments are possible. Therefore, the spirit and scope of the appended claims should not be limited to the description of the embodiments contained herein.

### Preparation Example 1

The following was the method to obtain the sample powder of the Preparation example 1: first, the water solution of gum arabic was prepared. The water solution of gum arabic was obtained by mixing the gum arabic and hot water with a temperature of 80° C. to 90° C. and a volume of 2 times to 4 times that of the gum arabic. Next, the water solution of gum arabic was mixed in the Camellia seed oil and stirred until the Camellia seed oil was emulsified to obtain an emulsified solution.

Next, the γ-cyclodextrin was added into the emulsified solution and stirred at 40° C. to 50° C. for 2 hours to obtain a modified emulsified solution. Then, the modified emulsified solution was passed through the microfluidic device to obtain a homogeneous solution. The flow rate of the microfluidic device was 5 L/hour, and the temperature of the microfluidic device was set at room temperature (e.g., 25° C.). Thereafter, the homogeneous solution was lyophilized by using a lyophilization machine to obtain the sample powder. The sample powder included 85 weight percent of the gum arabic, 5 weight percent of the γ-cyclodextrin, and 10 weight percent of the Camellia seed oil.

### Preparation Examples 2 to 6

The methods of manufacturing the sample powder of Preparation examples 2 to 6 were roughly the same as that of the sample powder of Preparation example 1 besides that the amounts of the gum arabic and Camellia seed oil were different. The sample powders of Preparation examples 2 to 6 included 20 weight percent, 25 weight percent, 30 weight percent, 35 weight percent, and 40 weight percent of the Camellia seed oil, respectively.

### Preparation Comparative Examples 1 to 3

The methods of manufacturing the sample powders of Preparation comparative examples 1 and 2 were the same as that of Preparation example 1, but γ-cyclodextrin was not added into the sample powder of the Preparation comparative example 1, and the sample powder of the Preparation comparative example 2 included more Camellia seed oil (50 weight percent). The method of manufacturing the sample powder of Preparation comparative example 3 was the same as that of Preparation example 3, but γ-cyclodextrin was replaced by corn dextrin in the sample powder of the Preparation comparative example 3. The compositions of the sample powders of Preparation examples 1 to 6 and Preparation comparative examples 1 to 3 were recorded in Table 1.

### Method of Evaluation and Result

### Loss Rate

The properties of encapsulation of the sample powders were evaluated with the loss rate. The method for the evaluation was briefly described as follows. First, the sample powders were mixed with n-hexane, and the Soxhlet extractor was used to extract oil at 45° C. to 55° C. for 6 hours to 8 hours, thereby obtaining the extract product. Then, the supernatant of the obtained extract product was concentrated to remove the solvent, thereby obtaining the oil. The percentage of the weight of oil to the weight of the sample powder was calculated to obtain the oil content in the sample powder. The loss percentage of the Camellia seed oil was obtained by calculating percentage of the difference between the amount of the Camellia seed oil used to make the sample powder and the amount of the Camellia seed oil included in the sample powder to the amount of the Camellia seed oil used to make the sample powder (equal to the difference between 100% and the percentage of the amount of Camellia seed oil used to make sample powder to the amount of Camellia seed oil contained in the sample powder).

### Determination of Stability

The sample powders were packed in aluminum bags, sealed, and stored in an environment of 40° C. and relative humidity of 75% for 3 months. The water content, the acid value, the total bacterial count, and the water activity of the sample powders were evaluated every week. The water activities of the sample powders were evaluated with a water activity detecting machine.

The detection of the acid values of the sample powders was referred to the standard National Standards of the Republic of China (CNS) 7527:2022 N5183 established by National Standards of the Republic of China. The brief description was as follows: after the sample powder was mixed with the solvent and added with a phenolphthalein indicator, potassium hydroxide (0.1 N) was used for titration until the indicator changed color. The volume of potassium hydroxide used for titration was recorded to calculate the acid value. The aforementioned solvent was a mixture of ethanol and ether in equal volumes.

The method to detect the total bacterial count of the sample powders was described as follows: the sample powder was solved in the LB culture solution, spread on the LB agar culture medium, and then cultured at 37° C. for 15 hours to 18 hours to obtain the total bacterial count of the sample powders.

The results of the water contents, the acid values, the water activities, and the total bacterial counts of the sample powders of Preparation examples 1 to 6 stored at room temperature for 1 to 12 weeks were analyzed and recorded in Table 2. The differences between groups were within +3%. The results of the water contents, the acid values, the water activities, and the total bacterial counts of the sample powders of Preparation comparative examples 1 to 3 were recorded in Table 3. In Tables 2 and 3, “V” represented that the total bacterial count was less than or equal to 1000 CFU/mL.

TABLE 1

| | | | | | | | | Preparation | | |
|---|---|---|---|---|---|---|---|---|---|---|
| | | Preparation example | | | | | | comparative example | | |
| Example | | 1 | 2 | 3 | 4 | 5 | 6 | 1 | 2 | 3 |
| Amount | Gum arabic | 85 | 75 | 70 | 65 | 60 | 55 | 90 | 45 | 70 |
| in the | γ- | 5 | 5 | 5 | 5 | 5 | 5 | 0 | 5 | 0 |
| sample | cyclodextrin | | | | | | | | | |
| powder | Corn dextrin | 0 | 0 | 0 | 0 | 0 | 0 | 0 | 0 | 5 |
| (wt %) | Camellia | 10 | 20 | 25 | 30 | 35 | 40 | 10 | 50 | 25 |
| | seed oil | | | | | | | | | |

| | | | | | | | | | |
|---|---|---|---|---|---|---|---|---|---|
| Oil content (%) | 9.80 | 19.25 | 24.33 | 29.24 | 34.66 | 38.99 | 9.40 | 46.31 | 24.35 |
| Loss rate (%) | 2.00 | 3.75 | 2.68 | 2.53 | 0.97 | 2.52 | 6.00 | 7.38 | 2.60 |

As shown in Table 1, the loss rates of the Camellia seed oil of the sample powders of Preparation examples 1 to 6 were 0.97% to 3.75%, lower than the loss rate (16% to 20%) of the Camellia seed oil of the sample powder made by conventional method. The sample powders of Preparation examples 1 to 6 kept pulverous after a storage period.

The γ-cyclodextrin was not added in the sample powder of Preparation comparative example 1. This, even though the amount of Camellia seed oil decreased, the loss rate of the Camellia seed oil was still high, indicating that the properties of encapsulation were bad. Moreover, the obtained sample powder of Preparation comparative example 1 was agglomerated and sticky after a storage period of 1 week, indicating that there was grease discharge and that the sample powder became wet more easily. The amount of Camellia seed oil of Preparation comparative example 2 was higher, but the amount of gum arabic was lower, so the loss rate of Camellia seed oil was high, indicating that the property of encapsulation was bad. Moreover, the obtained sample powder was agglomerated and sticky after a storage period of 1 week, indicating that there was grease discharge and that the sample powder became wet more easily. The corn dextrin was used in Preparation comparative example 3, and the obtained sample powder was agglomerated and sticky after a storage period of 1 week, indicating that there was grease discharge and that the sample powder became wet more easily.

TABLE 2

| | | | | Total |
|---|---|---|---|---|
| | Water content | Acid value | Water | bacterial |
| Evaluation result | (wt %) | (mg KOH/g) | activity | count |
| 1 week-storage | 2.60 | 0.68 | 0.2683 | V |
| 2 week-storage | 2.72 | 0.67 | 0.2100 | V |
| 3 week-storage | 3.09 | 0.73 | 0.4146 | V |
| 4 week-storage | 2.91 | 0.64 | 0.1180 | V |
| 6 week-storage | 3.05 | 0.84 | 0.1558 | V |
| 8 week-storage | 2.81 | 0.68 | 0.1435 | V |
| 10 week-storage | 2.64 | 0.76 | 0.1839 | V |
| 12 week-storage | 2.74 | 0.69 | 0.1974 | V |

As shown in Table 2, the water content, the acid value, and the water activity of sample powders of Preparation examples 1 to 6 did not tend to increase or decrease dramatically at the 12 weeks (about 3 months). The average of the water contents was less than 4.00 weight percent, the average of the acid values was less than 1.0 mg KOH/g, the average of the water activities was less than 0.3, and the average of the total bacterial counts was less than 1000 CFU/mL, indicating excellent stabilities.

TABLE 3

| | Water content | | | Acid value | | |
|---|---|---|---|---|---|---|
| Evaluation result | (wt %) | | | (mg KOH/g) | | |
| Preparation comparative | 1 | 2 | 3 | 1 | 2 | 3 |
| example | | | | | | |
| 1 week-storage | 3.42 | 3.26 | 3.71 | 0.79 | 0.81 | 0.83 |

| | | | | Total bacterial | | |
|---|---|---|---|---|---|---|
| Evaluation result | Water activity | | | count | | |
| Preparation comparative | 1 | 2 | 3 | 1 | 2 | 3 |
| example | | | | | | |
| 1 week-storage | 0.2796 | 0.3122 | 0.2796 | V | V | V |

As shown in Table 3, compared to the sample powders of Preparation examples 1 to 3, the sample powders of Preparation comparative examples 1 to 3 became agglomerated and sticky easily after a storage period of 1 week, and the water content, the acid value, and the water activity were higher, in which the water activities of Preparation comparative examples 2 and 3 were even bigger than 0.3. It could be speculated that after a longer storage period, the qualities of the sample powders of Preparation comparative examples 1 to 3 could further deteriorate and microorganisms could even grow therein, i.e., the stability was bad.

In sum, the specific kind and the specific amount of the aforementioned functional oil, the specific amount of cyclodextrin, the specific microfluidic device, the specific processing, and the specific evaluation method are shown in the present invention as examples to illustrate the method of manufacturing a functional oil powder of the present invention. However, it will be apparent to those skilled in the art that the present invention is not limited to what has been mentioned. Without departing from the scope or spirit of the invention, it is intended that other kinds and other amounts of the aforementioned functional oil, other amounts of cyclodextrin, other microfluidic devices, other specific processing, and other specific evaluation methods can also explain the present invention.

As shown in the aforementioned example, the method of manufacturing a functional oil powder of the present invention has the advantages of using cyclodextrin and the microfluidic device, so that the functional oil powder has properties of encapsulation and stability, and the method can be used to make functional oil into a food product that can be eaten directly.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method of manufacturing a functional oil powder, comprising:
mixing an emulsifier in a functional oil and stirring until the functional oil is emulsified to form an emulsified solution;
adding cyclodextrin to the emulsified solution, and stirring until the cyclodextrin forming a coating layer on a surface of the functional oil contained in the emulsified solution, thereby forming a modified emulsified solution;
perform a secondary emulsification with a microfluidic device by passing the modified emulsified solution through the microfluidic device, thereby obtaining a homogeneous solution, wherein the homogeneous solution comprises 55 weight percent to 85 weight percent of the emulsifier, 1 weight percent to 15 weight percent of the cyclodextrin, and 10 weight percent to 40 weight percent of the functional oil; and
lyophilizing the homogeneous solution to obtain the functional oil powder.

2. The method of manufacturing a functional oil powder of claim 1, wherein the functional oil comprises Camellia seed oil, pumpkin seed oil, Sacha inchi oil, and/or fish oil.

3. The method of manufacturing a functional oil powder of claim 1, wherein after adding the cyclodextrin in the emulsified solution, the stirring is performed at 40° C. to 50° C.

4. The method of manufacturing a functional oil powder of claim 1, wherein a pressure of the microfluidic device is set as 30 atmospheres (atm) to 50 atm.

5. The method of manufacturing a functional oil powder of claim 1, wherein a flowing rate of the microfluidic device is 1 L/hour to 10 L/hour.

6. The method of manufacturing a functional oil powder of claim 1, wherein a temperature of the microfluidic device is set as 10° C. to 40° C.

7. The method of manufacturing a functional oil powder of claim 1, wherein the secondary emulsification is performed at 10° C. to 40° C.

8. The method of manufacturing a functional oil powder of claim 1, wherein after a storage period, the functional oil powder has a water activity of less than 0.3.

9. The method of manufacturing a functional oil powder of claim 8, wherein the storage period is 1 week to 12 weeks.

10. The method of manufacturing a functional oil powder of claim 1, wherein after a storage period, the functional oil powder has a water content of less than 3.4 weight percentage.

11. The method of manufacturing a functional oil powder of claim 10, wherein the storage period is 1 week to 12 weeks.
